(19) United States
(12) Patent Application Publication
(10) Pub. No.: US 2003/0109304 A1
(43) Pub. Date: Jun. 12, 2003

(54) Gaming machine having dynamically controlled light display

(76) Inventor: Michael Gauselmann, Espelkamp (DE)

Correspondence Address: PATENT LAW GROUP LLP, 2635 NORTH FIRST STREET, SUITE 223, SAN JOSE, CA, 95134, US

(21) Appl. No.: 10/015,011

(22) Filed: Dec. 11, 2001

(51) Int. Cl. A63F 13/00

(52) U.S. Cl. 463/30

(57) ABSTRACT

A gaming machine includes a display, a memory, processing circuitry, and border surrounding a least a portion of the display. The border includes a plurality of lamps. In some embodiments, the lamps are red, blue, and green light emitting diodes covered by a semi-transparent cover. In some embodiments, the memory includes instructions for activating portions of the lamps in the border in order to increase the visual appeal and excitement of the game, to direct the player to different portions of the display, to direct the player to take some action, or to indicate the status of the machine. Thus, the lamps are dynamically controlled based on events occurring in the game, based on events occurring in the gaming machine platform itself, or based on other factors to not only create interest in playing the machine but also to inform a player or an attendant of certain events occurring in the machine.

### BACKGROUND

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available, because such machines attract frequent play and hence increase profitability to the operator. Accordingly, in the competitive gaming machine industry, there is a continuing need for gaming machine manufacturers to produce new types of games, or enhancements to existing games, which will attract frequent play by enhancing the entertainment value and excitement associated with the game.

### SUMMARY

In accordance with embodiments of the present invention, a gaming machine includes a display, a memory, processing circuitry, and border surrounding a least a portion of the display. The border includes a plurality of lamps. In some embodiments, the lamps are red, blue, and green light emitting diodes covered by a semi-transparent cover. In some embodiments, the memory includes instructions for activating the lamps in the border in a manner to increase the visual appeal and excitement of the game, to direct the player to different portions of the display, to direct the player to take some action, or to indicate the status of the machine. Thus, the lamps are dynamically controlled based on events occurring in the game, based on events occurring in the gaming machine platform itself (e.g., a malfunction), or based on other factors to not only create more excitement when playing the machine but also to inform a player or an attendant of certain events occurring in the machine.

### BRIEF DESCRIPTION OF THE DRAWINGS

FIG. 1 is a front view of a gaming machine.

FIG. 2 is block diagram of the components of a gaming machine.

FIG. 3 is a view of a portion of a display and border of a gaming machine.

FIG. 4 is a cross-sectional view of a border of a gaming machine.

### DETAILED DESCRIPTION

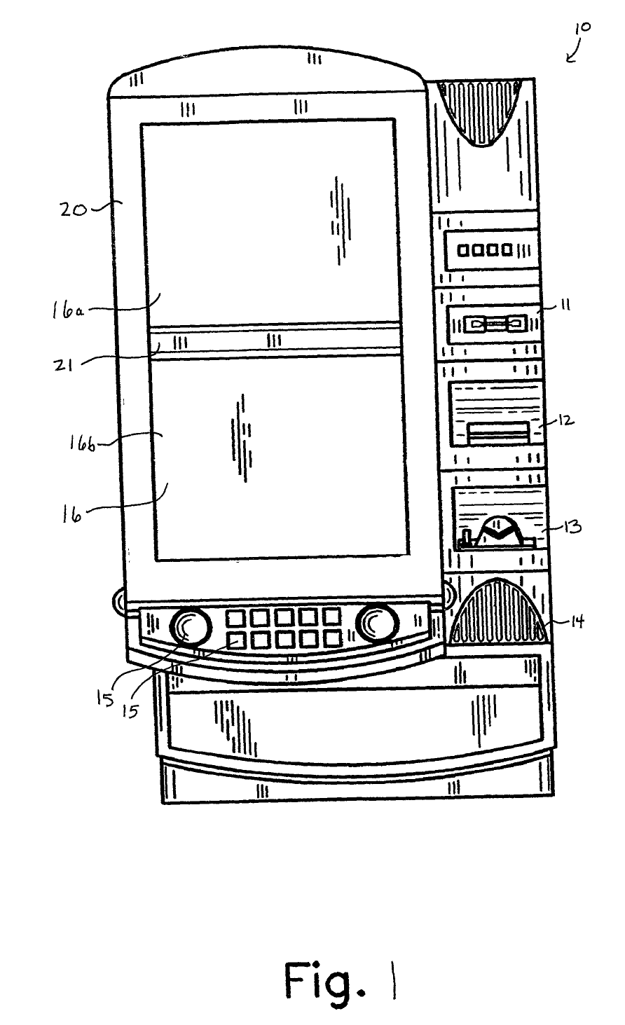

FIG. 1 illustrates a gaming machine 10 incorporating an embodiment of the present invention. Any type of game may be played on gaming machine 10, including but not limited to video-reel and rotatable-reel type symbol-matching games, video poker, bingo, and keno. Examples of such games are described in U.S. Pat. Nos. 6,110,040 and 6,270,412, incorporated herein by reference.

Gaming machine 10 may include a card reader 11, bill acceptor 12, and/or coin slot 13. A user of gaming machine 10 inputs coins into slot 13, bills into acceptor 12, or a card such as a smart card, a barcoded ticket, or a credit card into reader 11, in order to activate the game. The user controls the game by pushing buttons 15, such as for placing a bet, initiating the game, and cashing out.

The game is displayed on display 16, which may be a television monitor style CRT video display or a mechanical display such as rotatable reels or flip card carousels. Alternatively, display 16 may be a touch screen, in which case the user controls the game by touching different regions on the touch screen. Display 16 may be divided into multiple portions 16a and 16b, where different graphics may be displayed. For example, a main game may be played on display portion 16b. When the main game reaches a particular stage, a bonus game may be activated on display portion 16a. The visual display of the game on display 16 may be accompanied by sounds from speaker 14. Displays 16a and 16b may be separate CRTs or separate screens, or may be a divided screen.

Gaming machine 10 also includes a border 20 around display 16. Gaming machine 10 may optionally include a border section 21 separating two portions of display 16. Borders 20 and 21 may light up in different colors, with different brightness, with different types of motion, or with different speeds of motion, in order to enhance the visual appeal of the game played, direct the player to different portions of display 16, indicate when a player has won, indicate when a player has lost, or indicate the status of gaming machine 10, as described below.

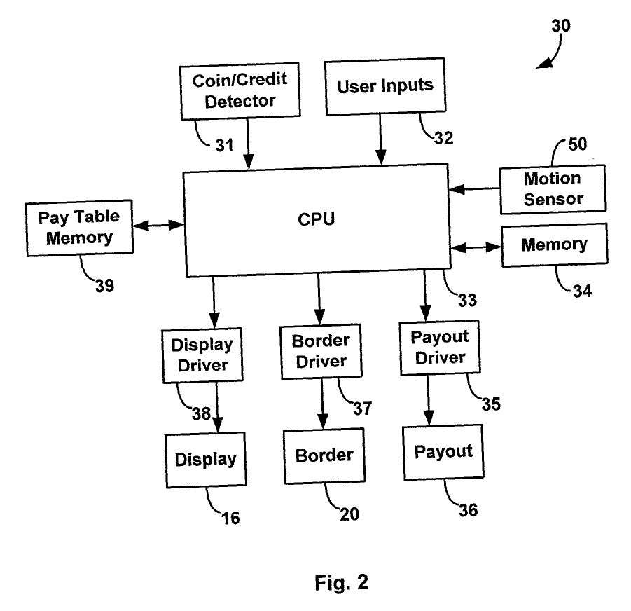

FIG. 2 illustrates circuitry 30 that may be used to implement gaming machine 10 of FIG. 1. As described above, to begin a game, a player inserts coins, bills, or a card into one of inputs 11, 12, or 13. A coin/credit detector 31 registers the input and instructs CPU 33 to begin the game. CPU 33 accesses memory 34, which stores the game program, and receives instructions for carrying out the game. Memory 34 may be ROM or any other type of memory external to or part of CPU 33. Circuitry 30 may include a random number generator for selecting cards to be displayed in a card game or for selecting symbols to be displayed across pay lines. CPU 33 receives instructions from memory 34, then instructs game display driver 38 to display an image on display 16 that is appropriate for the stage of the game. If the display 16 is not a video display, CPU 33 controls the motors of reels or other devices. CPU 33 may also instruct border driver 37 to start or change game border 20. Some processing may even be performed by a central server external to the gaming machine 10.

Border driver 37 may contain logic circuitry to receive simple commands from CPU 33, then output a dynamic series of commands necessary to control lamps 40 in a programmed manner. Such logic circuitry may comprise gate arrays, additional processing circuitry, or any other conventional circuitry. Border driver 37 may use a programmed memory (e.g., a portion of memory 34) to identify light patterns to be displayed by lamps 40. Additionally, border driver 37 may have a standby mode, where border driver 37 controls lamps 40 in an attention-getting manner without any control signals from CPU 33.

The player plays the game by pressing one or more of buttons 15, or by touching display 16 if display 16 is a touch screen. The user inputs 32 are received by CPU 33. CPU 33 may again access memory 34, then communicate new instructions to display driver 38 and/or border driver 37 to change display 16 and border 20. The color, intensity, or motion of border 20 may change each time display 16 is changed, or more or less frequently. After display 16 is changed, circuitry 30 may receive more inputs 32 from the player if the game is not finished. When the game is finished, CPU 33 accesses pay table memory 39, and receives instructions on how much to pay out. CPU 33 then instructs payout driver 35 to activate payout mechanism 36 to pay the player the appropriate winnings. Alternatively, the player accumulates credits until the player presses a button 15 to cash out. In some embodiments, drivers 35, 37, and 38 are connected to CPU 33 by an RS232 interface, a USB interface, or other connections.

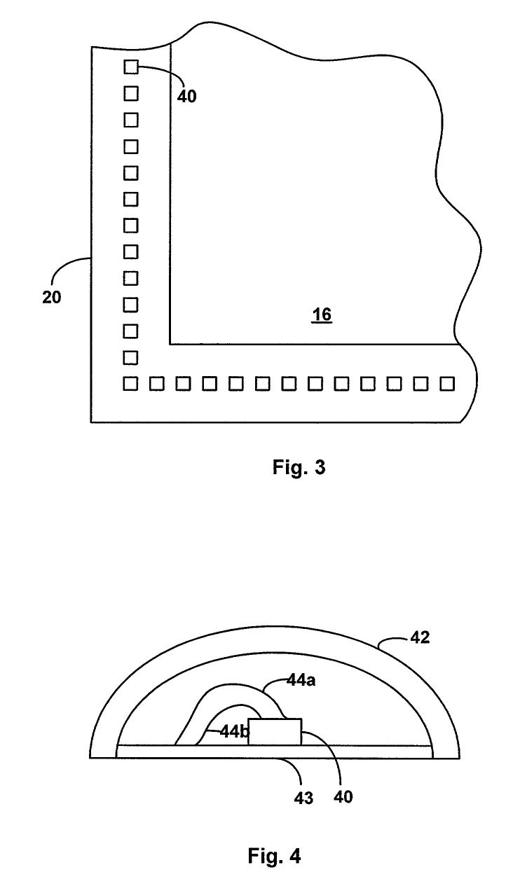

FIGS. 3 and 4 illustrate border 20 in more detail. FIG. 4 is a cross section of border 20. Turning now to FIG. 3, border 20 includes a group of colored lamps 40, such as light emitting diodes (LEDs) or incandescent bulbs. As shown in FIG. 3, lamps 40 may be arranged in a line. Lamps 40 may be arranged in other configurations besides a straight line. In one embodiment, lamps 40 are red, blue, and green LEDs arranged in a line of repeating groups of RGB LEDs. By activating different combinations of red, blue and green LEDs, different colors of light may be produced.

In FIG. 4, lamps 40 are attached to a base 43 and covered by a cover 42. Cover 42 may be a semi-transparent semicircular diffuser, which diffuses the light produced by lamps 40, making the entire surface of cover 42 glow and making it impossible for a user to determine which individual lamp is active at a given time. In some embodiments, the inside of cover 42 is coated with a diffusing material. Cover 42 may also be transparent.

Lamps 40 are turned on and off by voltage/current coupled to leads 44a and 44b connected to positive and negative terminals on each lamp. Each lamp 40 may be turned on, turned off, and adjusted for brightness by varying voltage or current to leads 44a and 44b. Leads 44a and 44b are electrically coupled to border driver 37, shown in FIG. 2. In one embodiment, border driver 37 controls lamps 40 for 16 steps in brightness. Each lamp 40 has its own set of leads 44a and 44b; thus, each of lamps 40 may be operated independently of the others. Border driver 37 may turn different lamps 40 on and off in patterns to give the illusion of motion in border 20, such as blinking or running lights.

In one embodiment, each lamp 40 is an LED that has two pin terminals. The pin terminals of many LEDs, such as along an edge of display 16, are soldered to a printed circuit (PC) board having thin conductive traces printed thereon. Thus, individual wires leading to each LED are avoided. Addressing or multiplexing circuitry may be mounted on the PC board to reduce the number of inputs to the PC board. Many other techniques can be used for electrically coupling lamps 40 to border driver 37.

Border driver 37 may operate border 20 independently of the game played on gaming machine 10, such as by displaying a running light independent of the game. Alternatively, border driver 37 may operate in conjunction with the game played on gaming machine 10. Border driver 37 may contain logic circuitry to receive simple commands from CPU 33, then output a dynamic series of commands necessary to control lamps 40 in a programmed manner. Such logic circuitry may comprise gate arrays, additional processing circuitry, or any other conventional circuitry. Additionally, border driver 37 may have a standby mode, where border driver 37 controls lamps 40 in an attention-getting manner without any control signals from CPU 33.

In some embodiments, border 20 may light up or change in conjunction with the game played on gaming machine 10 in such a way as to direct the player's attention to an aspect of the game. In one embodiment, border 20 directs the player to the portion of the screen that is active during each stage of the game. For example, a game played on gaming machine 10 may include a main game, played on the lower half 16b of display 16, and a bonus game, played on the upper half 16a of display 16. If the player wins the main game, the bonus game is activated. During the main game, the lower half of border 20 and middle border 21 may light up, directing the player's attention to display portion 16b. During the main game, the upper half of border 20 may be dark. When the player wins the main game, the lamps in the lower half of border 20 may turn off and the lamps in the upper half of border 20 may turn on, directing the player's attention from display portion 16b to display portion 16a, where the bonus game is played.

In one embodiment, border 20 may be illuminated in a distinct way for different stages of the game. Using the example of a gaming machine with a main game and a bonus game, border 20 may use one color, one type of motion, or one speed of motion to indicate the player is playing the main game and use a different color, type of motion, or speed of motion to indicate the player is playing the bonus game. Border 20 may use still different colors, types of motion, or speeds of motion to indicate that the player has won bonus prizes, to indicate that the player must respin, to indicate that the player has won a free game, and so forth.

In one embodiment, border 20 may be illuminated in distinct ways to indicate that a player has won, lost, or is currently playing a game. For example, border 20 may be yellow during a decision phase, for example, when a player must make a decision and press one of buttons 15 or an area on the touch screen in order to advance the game. When the game is over, border 20 may be green to indicate a player has won the game, or red to indicate a player has lost the game. Similarly, border 20 may be illuminated in distinct ways to indicate that the player has made good or bad decisions. For example, the game played on gaming machine 10 may involve a step where the player must decide to either take his current winnings or risk his winnings for a larger jackpot. Before the player chooses, border 20 may be illuminated with both red and green lights. If the player's decision results the player's winnings being higher, only the green lights in border 20 may be illuminated. If the player's decision results the player's winnings being lower, only the red lights in border 20 may be illuminated.

In one embodiment, border 20 may be illuminated in distinct ways to indicate different gambling features available to the player. For example, where a symbol combination only pays off if the matched symbols start from the leftmost end of a pay line, the lamps 40 may flash from left to right.

In some embodiments, border 20 may light up or change in conjunction with the game played on gaming machine 10 in such a way as to make the game more exciting. In one embodiment, the brightness or amount of movement in border 20 increases when a player has won the game or has won a jackpot. For example, while the game is being played, border 20 may be illuminated in a single color with no motion. When the player wins the game, different colors in border 20 may light up in quick succession, creating a colorful, quickly changing border.

In one embodiment, the motion of border 20 corresponds to the spinning of an actual or virtual reel being displayed in display 16. For example, when the player causes the reels of the machine to spin, adjacent lamps 40 in border 20 may be illuminated in succession, creating the illusion that border 20 is spinning in the same or opposite direction as the reels.

In one embodiment, the motion, brightness, or number of colors in border 20 may increase as the amount bet by the player increases. For example, if the player places the minimum bet, border 20 may be illuminated in a single color with no motion. As the player's bet increases, the type of motion, speed of motion, number of colors, and brightness of light may be increased to increase the excitement of gaming machine 10. In addition, the motion, brightness, or number of colors in border 20 may increase as the number of activated pay lines increases.

In one embodiment, border 20 may be illuminated in distinct ways when particular trigger symbols appear on display 16. For example, a special wildcard symbol may initiate flashing of lamps 40 or change the perceive color of lamps 40.

In one embodiment, the game played on gaming machine 10 may involve multiple regions displayed on display 16 adjacent to border 20, each region corresponding to a winning amount. The winning amounts of each region may or may not be displayed. The lamps in border 20 may flash randomly or in sequence. The flashing of the lamps may be stopped automatically or by the player pushing a button, leaving one lamp or all lamps corresponding to a single region illuminated. The player wins an amount displayed in the region adjacent to the lamp or lamps that remain illuminated when the flashing stops.

In one embodiment, when a player plays multiple games on a single gaming machine 10, each time the player wins a game, a portion of border 20 is illuminated. If the player wins enough games to illuminate all of border 20, the player may win an extra prize. Such a set up may entice a player to remain at a single machine for long periods of time, potentially increasing the profitability of that machine.

In one embodiment, as a bonus game, the player is offered two buttons (actual or touchscreen) that alternately blink. Pressing one of the buttons results in a win (e.g., doubling the win from the main game), and pressing the other button results in a loss (deleting the previous win amount from the main game). The player attempts to press the correct button. Flashing the border lamps in synchronization with the buttons adds excitement to the bonus game. Each button can be associated with a different color border display. If the player wins, she is given another opportunity to double her winnings by pressing one of the buttons, or she can press another button to quit. A win may cause the border lamps to flash in a different manner and/or the colors may change.

In some embodiments, border 20 may be used to indicate the status of gaming machine 10. Border 20 may be used to supplement or replace the status-indicating light on the top of gaming machines, also referred to as the candle. In one embodiment, border 20 may be illuminated in distinct ways to indicate that a coin hopper or bill stacker is full or empty. In another embodiment, border 20 may be illuminated in distinct ways to indicate when gaming machine 10 must be checked. For example, border 20 may have distinct patterns to indicate the machine door is open, the touch screen or buttons are out of order, or the machine is suffering from some other malfunction.

In still another embodiment, border 20 may be illuminated in a distinct way to point out a VIP player to service personnel, such that the player can be provided with special service. The player's card inserted into the machine 10 may indicate that the player is a VIP player, or the amount of betting by the player may classify the player as a VIP player. In another embodiment, border 20 may be illuminated in a distinct way to call an attendant. For example, for large wins, an attendant is called to pay the player rather than the player being paid from the coin hopper. In another embodiment, the amount of accumulated credit in the machine 10 may be reflected in the brightness of the lamps 40 or other visual characteristic of the lamps 40. In another example, the brightness of the lamps 40 or other visual characteristic of the lamps 40 may reflect the value of the win.

In some embodiments, border 20 is used in conjunction with a bank of gaming machines linked to each other. Such a system of linked gaming machines is described in more detail in U.S. Pat. No. 6,089,980, titled “Method For The Determination Of A Shared Jackpot Winning,” and incorporated herein by reference. In the system described in U.S. Pat. No. 6,089,980, the linked gaming machines jointly fill a jackpot. In one embodiment, border 20 may be used to signal the beginning of a competitive game or a jackpot game involving all the linked machines. For example, when a jackpot or competitive game begins, border 20 may be illuminated only on machines that are participating in the competitive or jackpot game. When the winner of the game is determined, the winning machine may be the only machine with border 20 illuminated, or the borders of all participating machines may illuminate in sequence, creating the illusion of a wave that stops at the winning machine.

In another embodiment, the borders of participating machines may light up then switch off in sequence. The machine on which the light stops is the winning machine. In another embodiment, some or all of the linked machines may win a portion of the jackpot, and the brightness or number of lamps lit in border 20 of each machine is proportional to the relative size of the machine's share of the jackpot.

In another embodiment, borders 20 on all the machines in an area of a casino or in an entire casino may “count down” to happy hour, by, for example, illuminating all or a portion of the lamps in border 20 ten seconds before happy hour begins, then turning off a portion of the illuminated lamps for each second that passes. When happy hour begins, all or a portion of the lamps in border 20 may illuminate again, with increased brightness or with increased motion.

In another embodiment a motion sensor 50 (FIG. 2) is added to gaming machine 10. Signals output by motion sensor 50 to CPU 33 identify that a person is walking by the machine. In response, the machine controls lamps 40 in border 20 in a manner (e.g., by flashing) to attract the person's attention to increase the chances that the person will play machine 10. Sensor 50 may be any conventional motion sensor.

While particular embodiments of the present invention have been shown and described, it will be obvious to those skilled in the art that changes and modifications may be made without departing from this invention in its broader aspects. For example, the invention is not limited to video gaming machines and may be applied to mechanical gaming machines such as reel slots, machines with rotating wheels, and flipcard units. Therefore, the appended claims are to encompass within their scope all such changes and modifications as fall within the true spirit and scope of this invention.

What is being claimed is:

1. A gaming system comprising:
a display;
a memory programmed for, at least, controlling a game played on the gaming system;
processing circuitry connected to receive instructions from the memory and to output signals for controlling the display; and
a border surrounding at least a portion of the display, the border comprising a plurality of lamps, the lamps being selectively illuminated, pursuant to signals from the processing circuitry, in a manner that changes based on variable aspects of the gaming system.

2. The gaming system of claim 1 wherein the lamps comprise light emitting diodes.

3. The gaming system of claim 2 wherein the light emitting diodes are red, blue, and green light emitting diodes.

4. The gaming system of claim 1 wherein the border further comprises a semi-transparent cover covering the lamps.

5. The gaming system of claim 4 wherein the cover comprises a light diffuser.

6. The gaming system of claim 1 wherein said processing circuitry comprises a border controller, said system further comprising a plurality of conductors connecting the lamps to the border controller.

7. The gaming system of claim 1 wherein the memory contains instructions for carrying out the following method performed by the gaming system:
displaying a first screen of a game;
activating lamps in the border in a first manner;
receiving an instruction from a player;
determining an outcome of the game following the instruction; and
activating lamps in the border in a second manner, different from the first manner, when the outcome is a winning outcome.

8. The gaming system of claim 7 wherein the memory contains instructions for carrying out the following method performed by the gaming machine:
activating lamps in the border in a third manner, different from the first manner and second manner, when the outcome is a losing outcome.

9. The gaming system of claim 1 wherein the memory contains instructions for carrying out the following method performed by the gaming machine:
displaying a first screen of a game on a first portion of the display;
activating a first portion of the lamps in the border, wherein the first portion of lamps are adjacent to the first portion of the display;
displaying a second screen of a game on a second portion of the display; and
activating a second portion of the lamps in the border, wherein the second portion of the lamps are adjacent to the second portion of the display.

10. The gaming system of claim 1 wherein the memory contains instructions for carrying out the following method performed by the gaming machine:
activating at least a portion of the lamps in the border; and
determining the brightness of the activated lamps based on an amount bet by a player.

11. The gaming system of claim 1 wherein the memory contains instructions for carrying out the following method performed by the gaming machine:
activating at least a portion of the lamps in the border; and
determining the brightness of the activated lamps based on a number of activated pay lines.

12. The gaming system of claim 1 wherein the memory contains instructions for carrying out the following method performed by the gaming machine:
displaying a first screen of a game, the first screen comprising a plurality of regions adjacent the border, each region corresponding to a winning amount;
flashing a plurality of lamps in succession, each flashing lamp being adjacent to one of the plurality of regions;
receiving an instruction to stop flashing;
causing a payout mechanism to pay an amount corresponding to a winning amount in a region adjacent to a last lamp illuminated prior to said receiving an instruction to stop flashing.

13. The gaming system of claim 1 wherein said display comprises a video display.

14. The gaming system of claim 1 wherein the processing circuitry comprises a border driver connected to the border.

15. The gaming system of claim 13 wherein the processing circuitry comprises a CPU coupled to the memory.

16. The gaming system of claim 1 wherein the variable aspects of the gaming system comprise changes in a status of the gaming system.

17. The gaming system of claim 1 wherein the variable aspects of the gaming system comprise changing aspects of a game being played on the gaming system.

18. The gaming system of claim 1 wherein the variable aspects of the gaming system comprise a jackpot being obtained by a player.

19. The gaming system of claim 1 wherein the variable aspects of the gaming system comprise at least one reel spinning.

20. The gaming system of claim 1 wherein the variable aspects of the gaming system comprise a win by a player requiring an attendant to attend to the player.

21. The gaming system of claim 1 wherein the gaming system comprises a plurality of linked gaming machines, and wherein the variable aspects of the gaming system comprise a win by a player on one of the linked machines causing the lamps on the one of the linked machines to be illuminated in a manner to distinguish the one of the linked machines from the remainder of the machines.

22. The gaming system of claim 1 wherein the variable aspects of the gaming system comprise the start of a competitive game in a plurality of linked gaming machines.

23 The gaming system of claim 1 wherein the variable aspects of the gaming system comprise when a coin hopper or bill stacker in the gaming system is fall or empty.

24. The gaming system of claim 1 wherein the variable aspects of the gaming system comprise when there is a malfunction of the gaming system.

25. A method performed by a gaming machine, the method comprising selectively illuminating a plurality of lamps in a border surrounding a display of the gaming machine, wherein the plurality of lamps are selectively illuminated in a manner that changes based on variable aspects of the gaming machine.

26. The method of claim 25 further comprising:
displaying a first screen of a game;
activating lamps in the border in a first manner;
receiving an instruction from a player;
determining an outcome of the game following the instruction; and
activating lamps in the border in a second manner, different from the first manner, when the outcome is a winning outcome.

27. The method of claim 26 further comprising:
activating lamps in the border in a third manner, different from the first manner and second manner, when the outcome is a losing outcome.

28. The method of claim 25, further comprising:
displaying a first screen of a game on a first portion of the display;
activating a first portion of the lamps in the border, wherein the first portion of lamps are adjacent to the first portion of the display;
displaying a second screen of a game on a second portion of the display; and
activating a second portion of the lamps in the border, wherein the second portion of the lamps are adjacent to the second portion of the display.

29. The method of claim 25, further comprising:
activating at least a portion of the lamps in the border; and
determining the brightness of the activated lamps based on an amount bet by a player.

30. The method of claim 25, further comprising:
activating at least a portion of the lamps in the border; and
determining the brightness of the activated lamps based on a number of activated pay lines.

31. The method of claim 25, further comprising:
displaying a first screen of a game, the first screen comprising a plurality of regions adjacent the border, each region corresponding to a winning amount;
flashing a plurality of lamps in succession, each flashing lamp being adjacent to one of the plurality of regions;
receiving an instruction to stop flashing; and
causing a payout mechanism to pay an amount corresponding to a winning amount in a region adjacent to a last lamp illuminated prior to said receiving an instruction to stop flashing.
